(19) United States
(12) Patent Application Publication
(10) Pub. No.: US 2003/0007117 A1
(43) Pub. Date: Jan. 9, 2003

(54) Channel to control seal width in optical devices

(76) Inventors: Douglas J. McKnight, Boulder, CO (US); Lance McCulloch, Boulder, CO (US)

Correspondence Address: INGRASSIA FISHER & LORENZ, P.C., 7150 E. CAMELBACK, STE. 325, SCOTTSDALE, AZ, 85251, US

(21) Appl. No.: 09/872,145

(22) Filed: Jun. 1, 2001

(51) Int. Cl. G02F 1/1339

(52) U.S. Cl. 349/153

(57) ABSTRACT

The present invention relates to optical devices. In one embodiment, a display apparatus includes a display medium, a transparent substrate, a non-transparent substrate. The display medium is disposed between the first and second substrates and an adhesive coupling material couples the substrates together. The adhesive material is disposed proximate to a channel, which is in at least one of the substrates.

### FIELD OF THE INVENTION

The invention relates to silicon processing where multiple layers of material are joined together with an adhesive material such as in Liquid Crystal on Silicon (LCoS) displays. The invention may be used to produce high quality static as well as dynamic real time color field micro images on an active pixel matrix.

### BACKGROUND OF THE INVENTION

Conventional flat-panel displays use electroluminescent materials or liquid crystals in conjunction with incident light to produce high quality images in products such as digital wristwatches, calculators, panel meters, thermometers, and industrial products. Liquid crystals (LCs) are liquids in which the molecules can be arranged to possess an orientational order, which in turn causes macroscopic optical properties such as birefringence to appear in the material. A liquid crystal display is made by disposing the liquid crystal material in a layer between two closely spaced, treated, substrates. This ordered structure can be deformed by application of an electric (or magnetic) field, and this deformation results in a change in the optical properties of the layer. By a suitable choice of external polarization control components, such as polarizers and retarders, the change in optical properties of the LC can result in a change in the amount of light transmitted or reflected by the LC display device. One approach for developing high quality liquid crystal displays (LCDs), also referred to as liquid crystal spatial light modulators (SLMs), utilizes an active-matrix approach where transistors, sometimes thin film transistors (TFTs), are operationally co-located with a matrix of LCD pixels. The active-matrix approach allows pixels to be independently addressed, which essentially eliminates cross-talk, and allows for other display quality improvements over passive matrix displays such as increased speed, and increased number of gray-scales.

Very small displays are sometimes termed micro-displays. Both reflective and transmissive micro-displays can be made, and they are used in applications such as camera viewfinders, display glasses and projector systems. Reflective micro displays are usually based on single-crystal silicon integrated circuit substrates with a reflective aluminum pixel forming a pixel mirror. Because it is reflective, the pixel mirror can be fabricated over the pixel transistors and addressing lines. This results in an aperture ratio (reflective area/absorptive area) that is much larger than equivalent transmissive displays. Aperture ratios for reflective displays can be greater than 90%. Because of the large aperture ratio and the high quality silicon transistors, the resolution of a reflective micro display can be very high within a viewing area that is quite small. For example, a QVGA (320×200) pixel display with a 12 μm pixel pitch has an active area of 3.84 mm×2.40 mm.

There are several different liquid crystal technologies that can be used in reflective micro displays. These include nematic liquid crystals, ferroelectric liquid crystal (FLC), and polymer disbursed liquid crystal (PDLC). Reflective micro displays are designed to be made as small as possible, because as the size increases the cost increases and yield decreases.

For further background in this area, see Douglas J. McKnight, et al., 256×256 Liquid-Crystal-on-Silicon Spatial Light Modulator, Applied Optics Vol. 33 No. 14 at 2775-2784 (May 10, 1994); and Douglas J. McKnight et al., Development of a Spatial Light Modulator: A Randomly Addressed Liquid-Crystal-Over-Nmos Array, Applied Optics Vol. 28 No. 22 (November 1989)

Liquid Crystal on Silicon (LCoS) displays are fabricated using a process that includes applying a sheet of glass over a silicon wafer (or chip). Typically the glass is glued to the underlying silicon wafer with an adhesive such as Mitsui XN-651, Mitsui XN-21, or World-Rock 780. The adhesive that is used forms a “gasket” around the active area of the display and is required both for mechanical strength and to keep the liquid crystal in place. It is either dispensed onto one of the substrates (usually the silicon) with a dispensing machine such as a Camalot, or is printed onto one of the substrates using a screen printing process. Subsequent to the dispensing process, the two substrates are mated together. Force is applied to squeeze the substrates together until the gap between them is at the desired size. Spacers that are dispersed between the silicon and the glass typically control the gap dimension.

It is desirable to control the amount of gasket material deposited on the substrate since the gasket material expands laterally as the substrate and top sheet are squeezed together. FIG. 1 shows a cross sectional view of part of a prior art assembly.

With reference to FIG. 1, adhesive 16 is contained between substrate 12 and top sheet 14. Lateral expansion can result in gasket width 20 reaching approximately five hundred microns, when display cell gap 18 is closed to approximately 2 microns. This result is undesirable since the cost of the display is related to the number of displays that can be placed on a single silicon wafer. For small displays, the area that has to be set aside for the gasket is significant. If the total display chip area is 7 mm by 7 mm, then this gasket occupies about 20% of the silicon area.

Often it is difficult to dispense a very small amount of adhesive without incurring problems such as the presence of unwanted breaches in the gasket. A breach in the gasket (other than the designed-in fill-port) results in a failed display, with resulting cost increases and reliability problems.

The problem of lateral gasket expansion worsens, as the cell gap is made smaller. For example, if a display were constructed with a cell gap of 1 micron, then the same gasket would spread out to approximately 1 mm in width. This situation presents several problems. First, the size of gasket occupies a very large fraction of the silicon area. Second, it requires more pressure to squeeze the gasket material out into such a thin, wide, strip. Third, the choice of some gap sizes may limit the use of conductive “crossover” material, which may be used to connect a transparent conductive layer on the glass to specific regions of metal on the silicon chip. If gap is too thin then the conductive crossover material can result in non-uniformity in the cell gap because the size of the conductive crossover material could prevent formation of the desired cell gap between the substrates at the crossover location(s). Fourth, some adhesives that are otherwise good for these applications contain a particulate “filler” material, that can limit the achievable cell gap to one which is larger than desired.

Prior art methods of applying adhesive gaskets result in large gasket width/gap ratios. What is needed in the art is a way of reducing lateral expansion of adhesive as the substrates are pressed together to form a finished gap there between.

### SUMMARY OF THE INVENTION

The present invention relates to methods and apparatuses directed to optical devices. In one embodiment, a display apparatus includes a display medium, a transparent substrate, a non-transparent substrate. The display medium is disposed between the first and second substrates and an adhesive coupling material couples the substrates together. The adhesive material is disposed proximate to a channel, which is in at least one of the substrates.

An optical apparatus, in one embodiment, includes_a non-transparent substrate; a transparent substrate; an adhesive material disposed on at least one of the transparent substrate and the non-transparent substrate; and a channel, formed in at least one of the transparent substrate and the non-transparent substrate, to receive a flow of the adhesive material.

A semiconductor method, in one embodiment, includes_applying a channel resist mask to at least one of a transparent substrate and a non-transparent substrate; and applying a dielectric-etch to form a channel, in at least one of the transparent substrate and the non-transparent substrate, to receive a flow of adhesive material.

### BRIEF DESCRIPTION OF THE DRAWINGS

FIG. 1 shows a cross sectional view of a prior art adhesive layer after assembly of the substrate with the top sheet.

FIG. 2 shows a. top view of a typical Liquid Crystal On Silicon (LCoS) display die.

FIG. 3 illustrates a cross-sectional view of the typical LCoS display shown in FIG. 2 cut along section A-A.

FIG. 3a shows several variations on the shape of the channel.

FIG. 3b depicts one of the many possible shapes the adhesive may assume within the channel.

FIG. 4 illustrates a combined isometric and cross-sectional view of an LCoS display.

### DETAILED DESCRIPTION

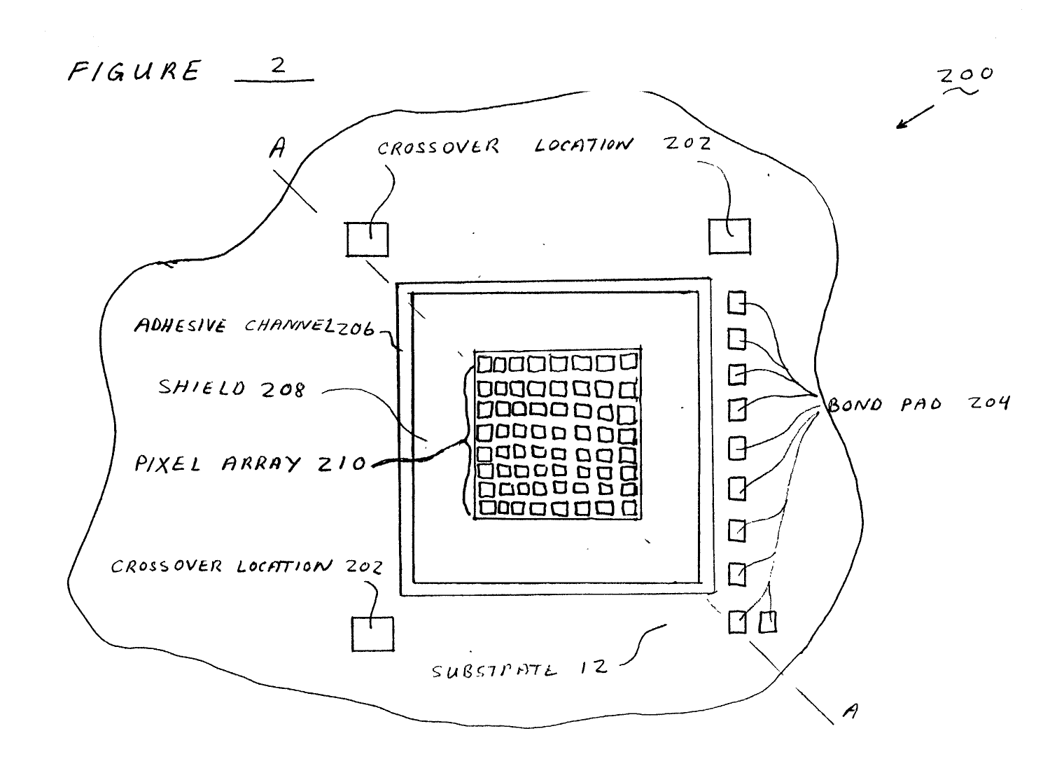

A top view of a typical LCoS display die is shown in FIG. 2. LCoS display device 200 is actually one of a plurality of such devices, which would be manufactured on a single silicon wafer. The present invention will be discussed with respect to a single LCoS display device. However, those of skill in the art will recognize that the invention is applicable in any application directed to limiting the lateral expansion of an adhesive/gasket material used in manufacturing optical devices with semiconductors. Additionally, the invention finds application to optical devices that are not manufactured with semiconductors.

With respect to semiconductor application, the present invention is employed on the active side of the silicon chip. The optical device may be similar to that described and shown in FIG. 7 of U.S. Pat. No. 5,426,526, which is hereby incorporated herein by reference. Reflective electrode 68 is on the active side of the silicon chip in FIG. 7 of U.S. Pat No. 5,426,526 as opposed to silicon substrate 60, which is the inactive side of the semiconductor. It will be appreciated that the “active” side of the semiconductor substrate is the side, which is doped to create the active devices (e.g. field effect transistors (FETs), etc.) as opposed to the backside of the semiconductor substrate or inactive side. It is typically true that the active side of the semiconductor substrate is also the side which interacts with light to create an optical device. Other examples of optical devices employing semiconductors are found in U.S. Pat. No. 6,046,716 which is hereby incorporated herein by reference.

Other hybrid technologies can be fabricated on semiconductor chips, and although they don't have the exact same requirements as LCoS devices, they can also benefit from improved adhesive ring control. These include organic light emitting diode on silicon displays, silicon-based micro-mechanical displays, and CCD or photodiode sensor arrays for cameras. Furthermore, these technologies that are primarily associated with displays can be used for applications other than displays. Both liquid crystal on silicon devices, and silicon based micro-mechanical devices can be used for optical applications such as laser beam steering.

With respect to application of the present invention to optical devices that do not employ particular use of semiconductors, the present invention is useful in, for example, reflective liquid crystal light valves such as those described in U.S. Pat. No. 4,019,807 and U.S. Pat. No. 4,378,955. Other examples would be passive matrix type Organic Light Emitting Diode (OLED) displays and passive matrix LCDs.

With reference to FIG. 2, pixel array 210 is configured as shown and surrounded by shield 208. Exterior to shield 208 is adhesive channel 206. In one embodiment, of the present invention, adhesive channel 206 extends around the periphery of shield 208 and contains the active display area interior to adhesive channel 206. Crossover locations 202 are placed exterior to, or inside, adhesive channel 206. There may be one or more bond pads 204 located exterior to adhesive channel 206. A typical LCoS display may have thirty bond pads.

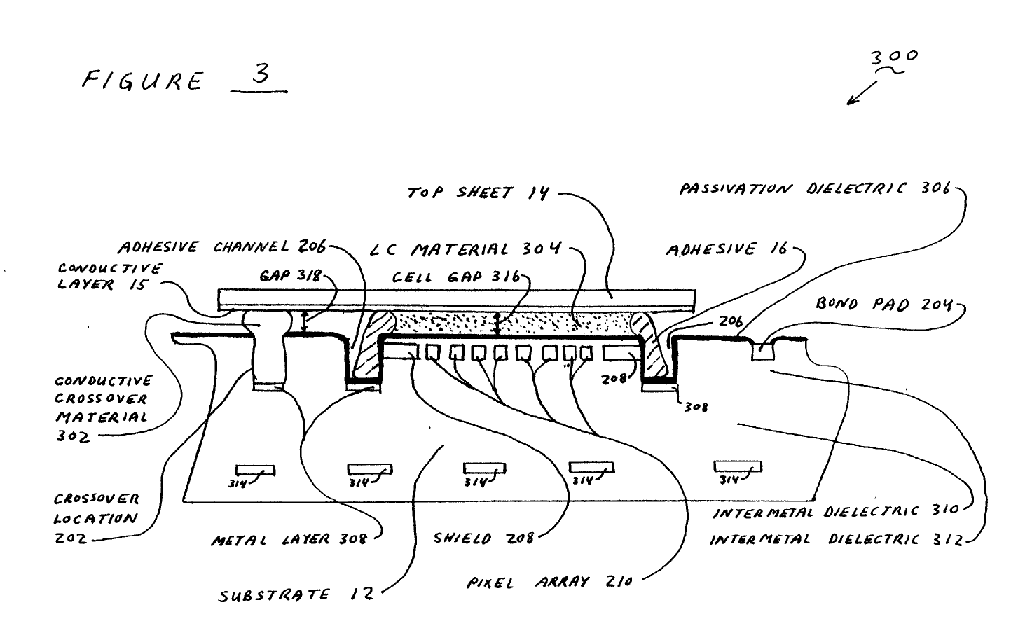

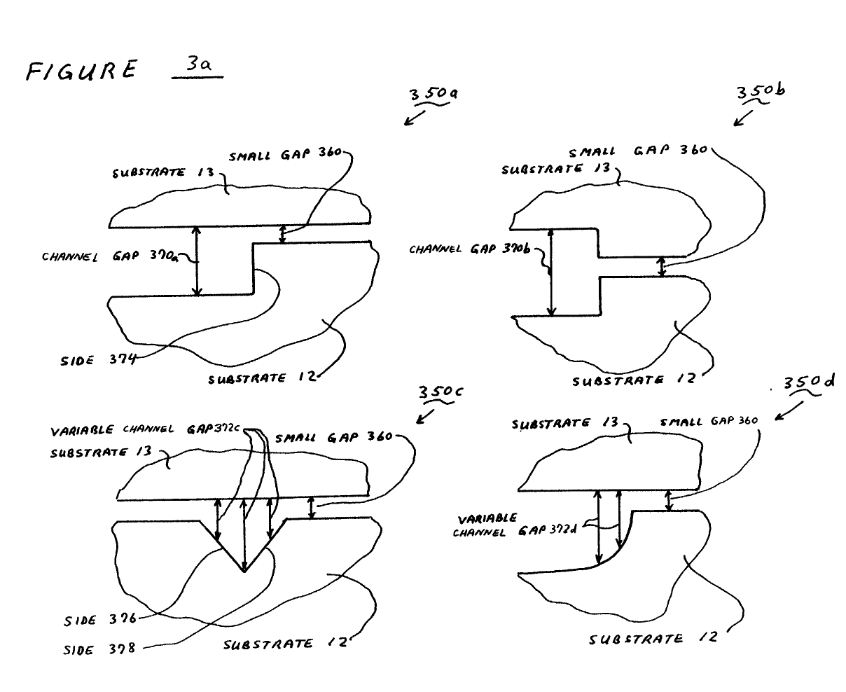

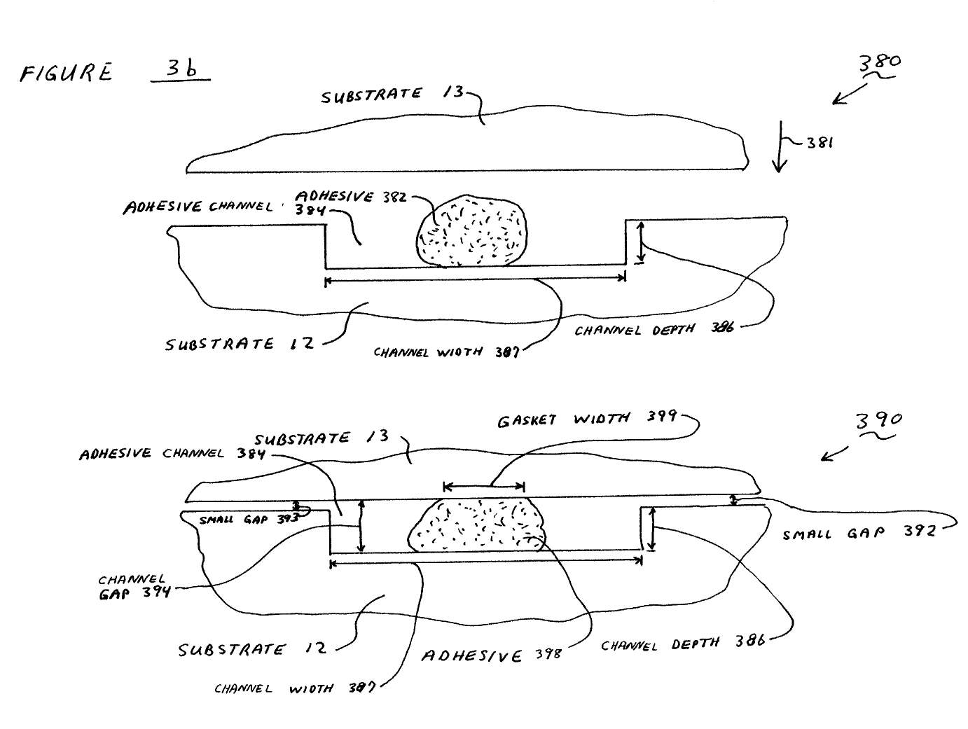

FIG. 3 illustrates a cross-sectional view of the typical LCoS display die shown in FIG. 2 cut along section A-A. The problem of large gasket width/gap ratio is solved by forming a “channel” around the peripheral area of the display on the silicon chip. With reference to FIG. 3, adhesive 16 is deposited proximate to adhesive channel 206. Proximate, as used herein, means either in the adhesive channel or near the adhesive channel. Channel cross-section 300 illustrates the LCoS display after top sheet 14 has been pressed against substrate 12. Top sheet 14 can be alternatively referred to as a substrate. No limitation is implied by the use of the term top sheet. Top sheet is used simply for clarity and convenience. LC material 304 is contained between substrate 12 and top sheet 14. In one embodiment of the present invention, adhesive channel 16 provides a reservoir of extra volume for adhesive 16 to flow into during assembly. Thus, mitigating the problems of excessive adhesive spread and large press pressures described above.

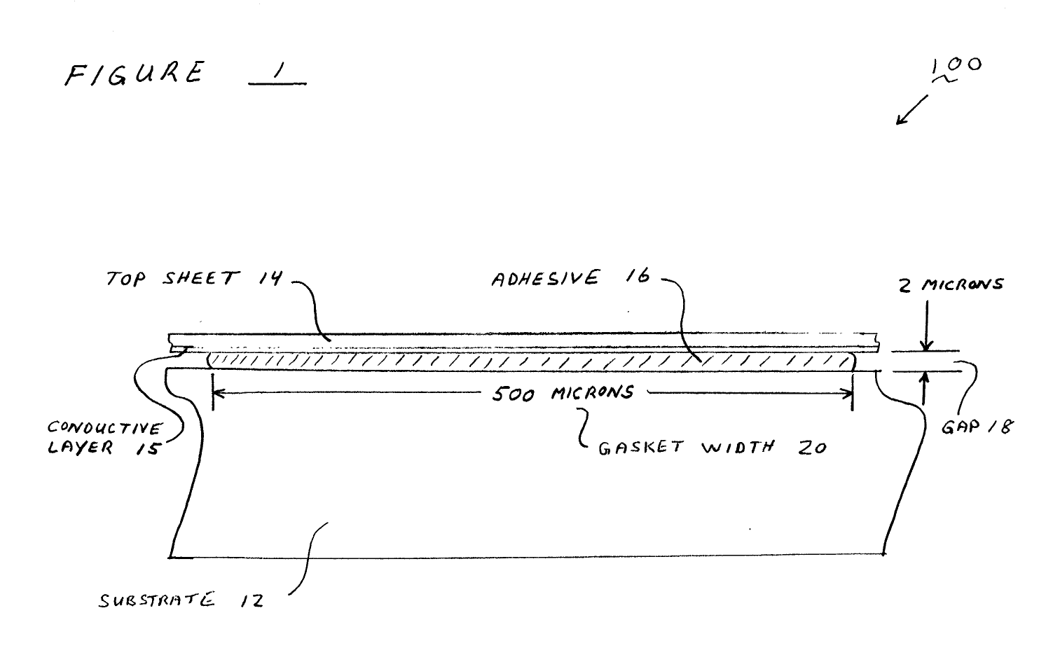

In one embodiment, adhesive 16, deposited proximate to adhesive channel 206, will spread, uniformly at first, during assembly (since adhesive 16 would flow through a uniform gap dimension) until adhesive 16 reaches adhesive channel 206, at which time adhesive 16 will be disposed to flow into the channel rather than away from the channel. Predisposition of the flow of adhesive 16 results from the larger gap presented to adhesive 16, by adhesive channel 206, as opposed to cell gap 316. The frictional force generated by the flow of adhesive 16 is inversely related to gap thickness. For example, the larger gap presented by adhesive channel 16, interacts with adhesive 16 to generate a lower frictional force (to oppose flow), as adhesive 16 expands during assembly of top sheet 14 with substrate 12. Thus, adhesive 16 flows into adhesive channel 206 rather than spreading widely as shown in FIG. 1.

Adhesive channel 206 is not limited to the rectangular cross section shown in FIG. 3. Adhesive channel 206 may be formed into any shape that presents an increase in gap thickness relative to the gap thickness presented to the adhesive in the region where the gasket width is to be contained. When the term “channel” is used in the context of the present invention, the channel need not be closed or symmetric about a geometric axis. The channel need only create a difference in gap dimensions, as previously discussed, when substrate 12 is moved proximate to top sheet 14, as shown in FIG. 3.

FIG. 3a illustrates several typical “channels” according to the use of the term channel herein. With reference to FIG. 3a, open channel 350a is shown within substrate 12. The term “open” indicates that there is no side opposing side 374. The desired geometry, the difference in gaps, is achieved since channel gap 370a is larger than small gap 360. A variation on open channel 350a is created with “double” open channel 350b. Both substrate 12 and substrate 13 are non-planar such that a channel is formed in each substrate, hence the use of the term double. The desired difference in gaps is obtained and it is readily evident that channel gap 370b is larger than small gap 360.

The channel gap need not be a constant dimension but may be a variable dimension. Closed variable channel 350c illustrates one such geometry. The term “closed” indicates that the channel has sides opposing each other, such as side 376 and side 378. Variable channel gap 372c varies from small to large to small as the channel is traversed from side 376 to side 378. This channel could be termed closed and is also symmetric about a vertical axis centered on the intersection of side 376 and 378. Closed variable channel 350c provides the desired relationship where variable channel gap 372c is greater than small gap 360.

Alternatively, the variable channel could be open as illustrated with variable open channel 350d. Variable open channel gap 372d follows a curve, which provides for an increasing channel gap as the distance away from small gap 360 increases.

In another embodiment of the present invention, the adhesive may be initially deposited within the channel. With reference to FIG. 3b, unassembled view 380 illustrates substrate 12 and substrate 13 with adhesive 382 contained within adhesive channel 384. Assembly of the substrates proceeds by moving substrate 12 and substrate 13 together. One method would be to move substrate 13 in the direction indicated by arrow 381. Assembled view 390 illustrates the position of substrate 12 and substrate 13 after the substrates have been moved close enough to create the desired small gap 392. During assembly, adhesive 382 may change shape to a shape similar to that depicted by adhesive 398, resulting in gasket width 399. Alternatively, more adhesive could have been deposited in adhesive channel 384 than that shown in unassembled view 380 such that upon assembly, adhesive 398 filled adhesive channel 384 and flowed into small gap 392. Such a condition would effectively produce a gasket width roughly equivalent to channel width 387. Adhesive 398 may assume a variety of shapes in adhesive channel 384 and may flow into small gap 392, small gap 393 or a combination of each of these gaps depending on the initial location of adhesive 398 deposited proximate to adhesive channel 384 and the amount of adhesive deposited therein. Channel depth 386 and channel width 387 can be varied without departing from the teaching of the invention. The channel should be properly sized so as not to occupy too much silicon area, and not be so small that adhesive gasket expansion is too large. A channel depth of 1.4 μm and a channel width 300 μm has been used to create a gasket width of approximately 200 μm in one application of the present invention.

The channel illustrated in FIG. 3 is created in a typical 3 layer metal CMOS silicon substrate with inter-metal dielectric 310 disposed between metal layer 314 and metal layer 308 and inter-metal dielectric 310 being disposed between metal layer 308 and the metal layer used for pixel array 210. Inter-metal dielectric 310 and inter-metal dielectric 312 may be made of the same or different material depending on the particular design of substrate 12. However, the following concepts and procedures apply to all typical semiconductor processes. Modifications described herein were all made to standard silicon processes, such as resist coat and lithography masking steps, fluorine based plasma dielectric plasma etching, and chlorine based plasma metal etching. In one embodiment, of the present invention, a mask is applied so that chlorine based plasma etching may be used to etch through shield 208, thus exposing inter-metal dielectric 310. A channel resist mask may be applied leaving the adhesive channel 206 and crossover location 202 exposed. A dielectric-etch is applied to create the channel to a specified depth. Etching may be terminated prior to reaching metal layer 308. Termination of etching ensures that some amount of inter-metal dielectric 310 is left over metal layer 308, under adhesive channel 206. Following channel resist removal, passivation dielectric 306 may be applied to substrate 12. A bond pad/crossover mask is applied that exposes crossover location 202 and bond pad 204 areas. Dielectric-etch is applied to remove any dielectric above bond pad 204 and above crossover location 202. The etching time is governed by the removal of dielectric in the crossover area. The time required for complete etching in the crossover area provides excessive etching time for dielectric above bond pad 204. However, this does not present a problem since bond pad 204 metal is removed very slowly in a dielectric plasma etch process.

Alternatively, according to another embodiment of the present invention, channel etching could be allowed to remove all of inter-metal dielectric 310 over metal layer 308, directly beneath adhesive channel 206, resulting in metal layer 308 being exposed at crossover location 202 and at adhesive channel 206. Bond pad 204 metal would also be exposed following this dielectric-etch process.

Passivation dielectric 306 is then applied. Passivation dielectric 306 may be removed from bond pad 204 and crossover location 202. The second approach may be easier to process, if metal layer 308 exists under adhesive channel 206. It will be noted by those of skill in the art that this alternative method of forming adhesive channel 206 can be employed even if no metal layer existed under adhesive channel 206.

Furthermore, the same processes can be used to increase gap 318 in the region of crossover location 202. Thus allowing use of conductive cross over material 302 which may require gap 318 to be larger than cell gap 316.

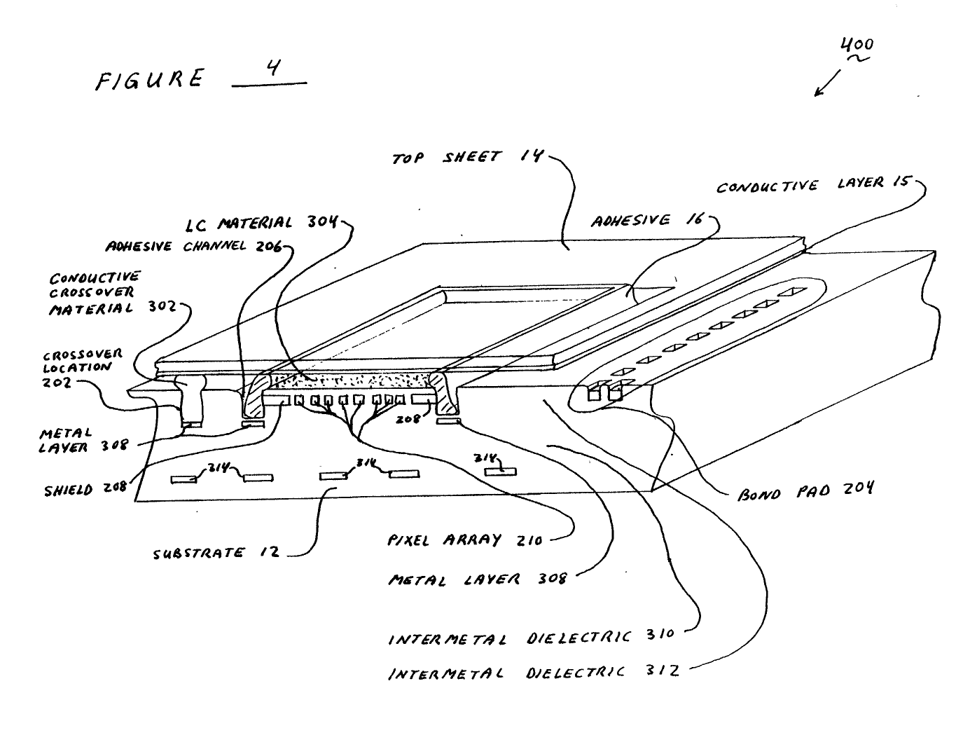

FIG. 4 illustrates a combined isometric and cross-sectional view of a LCoS display die. With reference to FIG. 4, isometric cross-section 400 illustrates an assembled LCoS display. Conductive crossover material 302 is deposited in crossover location 202 subsequent to the final processing that leaves metal layer 308 exposed. Conductive crossover material 302 is typically made of nickel particles or gold-coated plastic spheres. Conductive layer 15 applied to the underside of top sheet 14 is typically made of Indium Tin Oxide (ITO). Conductive crossover material 302 enables electrical continuity between metal layer 308 and conductive layer 15. It is important that the processing used on substrate 15 prior to assembly of the LCoS display leave metal layer 308 clean, in crossover location 202, so that good electrical contact can be made by conductive crossover material 302.

In the foregoing detailed description, the apparatuses and methods of the present invention have been described with reference to specific exemplary embodiments. However, it will be evident that various modifications and changes may be made without departing from the broader scope and spirit of the present invention. The present specification and figures are accordingly to be regarded as illustrative rather than restrictive.

What is claimed is:

1. A display apparatus comprising:
a display medium;
a transparent substrate;
a non-transparent substrate, said display medium being disposed between said transparent substrate and said non-transparent substrate; and
an adhesive material coupling said transparent substrate and said non-transparent substrate said adhesive material being disposed proximate to a channel which is in at least one of said transparent substrate and non-transparent substrate.

2. An apparatus, as in claim 1, wherein said display medium is a liquid crystal material.

3. An apparatus, as in claim 1, wherein at least one of said transparent substrate and said non-transparent substrate is made, at least in part, with silicon.

4. An apparatus, as in claim 1, wherein at least one of said transparent substrate and said non-transparent substrate is made, at least in part, with glass.

5. An apparatus, as in claim 2, wherein at least one of said transparent substrate and said non-transparent substrate is an integrated circuit.

6. An apparatus, as recited in claim 1, wherein said adhesive material is disposed adjacent to said channel.

7. An apparatus, as recited in claim 1, wherein a flow of the adhesive material in a direction away from a display area is minimized.

8. An optical apparatus comprising:
a non-transparent substrate;
a transparent substrate;
a channel, formed in at least one of said transparent substrate and said non-transparent substrate, to receive a flow of adhesive material disposed proximate to said channel;
wherein the adhesive material is disposed between said transparent substrate and said non-transparent substrate and couples said transparent substrate and said non-transparent substrate together.

9. An apparatus, as in claim 8, wherein at least one of said transparent substrate and said non-transparent substrate is made, at least in part, with silicon.

10. An apparatus, as recited in claim 8, wherein at least one of said transparent substrate and said non-transparent substrate is made, at least in part, with glass.

11. An apparatus, as recited in claim 8, wherein the adhesive material is disposed adjacent to said channel.

12. An apparatus, as recited in claim 8, wherein a flow of the adhesive material in a direction away from a display area is minimized.

13. An apparatus, as in claim 8, further comprising a display medium.

14. An apparatus, as in claim 13, wherein said display medium is a liquid crystal material.

15. An apparatus, as in claim 8, further comprising at least a first metal layer and a second metal layer.

16. An apparatus, as in claim 8, further comprising a passivation dielectric layer.

17. An apparatus, as in claim 16, further comprising a liquid crystal material wherein said liquid crystal material is disposed between said transparent substrate and said non-transparent substrate.

18. An apparatus, as recited in claim 17, wherein at least one of said transparent substrate and said non-transparent substrate is made, at least in part, with glass.

19. An apparatus, as in claim 18, wherein at least one of said transparent substrate and said non-transparent substrate has a conductive layer coupled therewith.

20. An apparatus, as in claim 19, further comprising a conductive crossover material wherein said conductive crossover material is disposed between said conductive layer and at least one of said first metal layer and said second metal layer.

21. An apparatus, as in claim 20, further comprising at least one bond pad coupled with at least one of said first metal layer and said second metal layer.

22. An optical apparatus comprising:
a non-transparent substrate;
a transparent substrate;
an adhesive material disposed on at least one of said transparent substrate and said non-transparent substrate; and
a channel, formed in at least one of said transparent substrate and said non-transparent substrate, to receive a flow of said adhesive material.

23. An apparatus, as recited in claim 22, wherein at least one of said transparent substrate and said non-transparent substrate is made, at least in part, with silicon.

24. An apparatus, as recited in claim 22, wherein at least one of said transparent substrate and said non-transparent substrate is made, at least in part, with glass.

25. An apparatus, as recited in claim 22, wherein said adhesive material is disposed adjacent to said channel.

26. An apparatus, as recited in claim 22, wherein a flow of said adhesive material in a direction away from a display area is minimized.

27. An apparatus, as in claim 22, further comprising a display medium.

28. An apparatus, as in claim 26, wherein said display medium is a liquid crystal material.

29. An apparatus, as in claim 22, further comprising at least a first metal layer and a second metal layer.

30. An apparatus, as in claim 29, further comprising a passivation dielectric layer.

31. An apparatus, as in claim 30, further comprising a display medium.

32. An apparatus, as in claim 31, further comprising a liquid crystal material.

33. An apparatus, as in claim 32, wherein at least one of said transparent substrate and said non-transparent substrate having a conductive layer coupled therewith.

34. An apparatus, as in claim 33, further comprising a conductive crossover material wherein said conductive crossover material is disposed between said conductive layer and at least one of said first metal layer and said second metal layer.

35. An apparatus, as in claim 34, further comprising at least one bond pad coupled with at least one of said first metal layer and said second metal layer.

36. A semiconductor method comprising:
applying a channel resist mask to at least one of a transparent substrate and a non-transparent substrate; and
applying a dielectric-etch to form a channel, in at least one of the transparent substrate and the non-transparent substrate, to receive a flow of adhesive material.

37. A method, as in claim 36, wherein the dielectric-etch is fluorine based.

38. A method, as in claim 36, wherein at least one of the transparent substrate and the non-transparent substrate is made, at least in part, with silicon.

39. A method, as in claim 36, wherein said method further comprises depositing passivation dielectric onto at least one of the transparent substrate and the non-transparent substrate.

40. A method, as in claim 36, wherein said method further comprises removing the channel resist mask.

41. A method, as in claim 40, further comprising applying a pad resist mask.

42. A method, as in claim 41, further comprising applying a dielectric-etch.

43. A method, as in claim 42, wherein the dielectric-etch is fluorine based.

44. A method, as in claim 36, wherein said method further comprises applying a metal mask.

45. A method, as in claim 44, wherein said method further comprises applying a metal-etch.

46. A method, as in claim 45, wherein the metal etch is chlorine based.

47. A method, as in claim 36, wherein said method further comprises dispensing the adhesive material along the channel.

48. A method, as in claim 47, wherein said method further comprises depositing a liquid crystal (LC) material on at least one of the transparent substrate and the non-transparent substrate, within an area bounded by the channel.

49. A method, as in claim 48, wherein said method further comprises applying a conductive crossover material to at least one location on at least one of the transparent substrate and the non-transparent substrate.

50. A method, as in claim 49, wherein said method further comprises coupling a conductive layer to at least one of the transparent substrate and the non-transparent substrate and wherein the LC material and the conductive crossover material is contained between the transparent substrate and the non-transparent substrate.

51. A semiconductor method comprising:
applying a channel resist mask to at least one of a transparent substrate and a non-transparent substrate;
applying a dielectric-etch to form a channel in at least one of the transparent substrate and the non-transparent substrate; and
dispensing adhesive material proximate to the channel.

52. A method, as in claim 51, wherein the dielectric-etch is fluorine based.

53. A method, as in claim 51, wherein at least one of the transparent substrate and the non-transparent substrate is made, at least in part, with silicon.

54. A method, as in claim 51, wherein said method further comprises depositing passivation dielectric onto at least one of the transparent substrate and the non-transparent substrate.

55. A method, as in claim 51, wherein said method further comprises removing the channel resist mask.

56. A method, as in claim 55, wherein said method further comprises depositing a passivation dielectric onto at least one of the transparent substrate and the non-transparent substrate.

57. A method, as in claim 56, wherein said method further comprises applying a pad resist mask.

58. A method, as in claim 53, wherein said method further comprises applying a metal mask.

59. A method, as in claim 58, wherein said method further comprises applying a metal-etch.

60. A method, as in claim 59, wherein the metal-etch is chlorine based.

61. A method, as in claim 51, wherein said method further comprises depositing a liquid crystal (LC) material on at least one of the transparent substrate and the non-transparent substrate, within an area bounded by the channel.

62. A method, as in claim 61, wherein said method further comprises applying a conductive crossover material to at least one location on at least one of the transparent substrate and the non-transparent substrate.

63. A method, as in claim 62, wherein said method further comprises coupling a conductive layer coupled to at least one of the transparent substrate and the non-transparent substrate and wherein the LC material and the conductive crossover material is contained between the transparent substrate and the non-transparent substrate.

64. An optical apparatus comprising:
means for applying a channel resist mask to a substrate; and
means for applying a dielectric-etch to form a channel, in the substrate, to receive a flow of adhesive material.

65. An optical apparatus comprising:
means for applying a channel resist mask to a substrate;
means for applying a dielectric-etch to form a channel in the substrate; and
means for dispensing adhesive material proximate to the channel.

66. An optical apparatus comprising:
a non-transparent substrate;
a transparent substrate;
a channel, formed in at least one of said transparent substrate and said non-transparent substrate, to receive a flow of adhesive material disposed adjacent to said channel;
wherein the adhesive material is disposed between said transparent substrate and said non-transparent substrate and couples said transparent substrate and said non-transparent substrate together.

67. An apparatus, as in claim 66, wherein at least one of said transparent substrate and said non-transparent substrate is made, at least in part, with silicon.

68. An apparatus, as recited in claim 66, wherein at least one of said transparent substrate and said non-transparent substrate is made, at least in part, with glass.

69. An apparatus, as recited in claim 66, wherein the adhesive material is disposed adjacent to said channel.

70. An apparatus, as recited in claim 66, wherein a flow of the adhesive material in a direction away from a display area is minimized.

71. An apparatus, as in claim 66, further comprising a display medium.

72. An apparatus, as in claim 71, wherein said display medium is a liquid crystal material.

73. An apparatus, as in claim 66, further comprising at least a first metal layer and a second metal layer.

74. An apparatus, as in claim 66, further comprising a passivation dielectric layer.

75. An apparatus, as in claim 71, further comprising a liquid crystal material wherein said liquid crystal material is disposed between said transparent substrate and said non-transparent substrate.

76. An apparatus, as recited in claim 75, wherein at least one of said transparent substrate and said non-transparent substrate is made, at least in part, with glass.

77. An apparatus, as in claim 76, wherein at least one of said transparent substrate and said non-transparent substrate has a conductive layer coupled therewith.

78. An apparatus, as in claim 77, further comprising a conductive crossover material wherein said conductive crossover material is disposed between said conductive layer and at least one of said first metal layer and said second metal layer.

79. An apparatus, as in claim 78, further comprising at least one bond pad coupled with at least one of said first metal layer and said second metal layer.

80. A semiconductor method comprising:
applying a channel resist mask to at least one of a transparent substrate and a non-transparent substrate; and
applying a dielectric-etch to form a channel, in at least one of the transparent substrate and the non-transparent substrate, to receive a flow of adhesive material disposed adjacent to the channel.

81. A method, as in claim 80, wherein the dielectric-etch is fluorine based.

82. A method, as in claim 80, wherein at least one of the transparent substrate and the non-transparent substrate is made, at least in part, with silicon.

83. A method, as in claim 80, wherein said method further comprises depositing passivation dielectric onto at least one of the transparent substrate and the non-transparent substrate.

84. A method, as in claim 80, wherein said method further comprises removing the channel resist mask.

85. A method, as in claim 84, further comprising applying a pad resist mask.

86. A method, as in claim 85, further comprising applying a dielectric-etch.

87. A method, as in claim 86, wherein the dielectric-etch is fluorine based.

88. A method, as in claim 80, wherein said method further comprises applying a metal mask.

89. A method, as in claim 88, wherein said method further comprises applying a metal-etch.

90. A method, as in claim 89, wherein the metal etch is chlorine based.

91. A method, as in claim 80, wherein said method further comprises dispensing the adhesive material along the channel.

92. A method, as in claim 91, wherein said method further comprises depositing a liquid crystal (LC) material on at least one of the transparent substrate and the non-transparent substrate, within an area bounded by the channel.

93. A method, as in claim 92, wherein said method further comprises applying a conductive crossover material to at least one location on at least one of the transparent substrate and the non-transparent substrate.

94. A method, as in claim 93, wherein said method further comprises coupling a conductive layer to at least one of the transparent substrate and the non-transparent substrate and wherein the LC material and the conductive crossover material is contained between the transparent substrate and the non-transparent substrate.
